(19) United States
(12) Patent Application Publication
(10) Pub. No.: US 2026/0227425 A1
(43) Pub. Date: Aug. 6, 2026

(54) VEHICLE SPEED ESTIMATION METHOD

(71) Applicant: TOYOTA JIDOSHA KABUSHIKI KAISHA, Toyota-shi (JP)

(72) Inventors: Takeru SHIRASAWA, Sunto-gun (JP); Ryosuke KAYANUMA, Sunto-gun (JP); Yusuke SAITO, Gotemba-shi (JP)

(73) Assignee: TOYOTA JIDOSHA KABUSHIKI KAISHA, Toyota-shi (JP)

(21) Appl. No.: 19/330,184

(22) Filed: Sep. 16, 2025

(30) Foreign Application Priority Data
Jan. 31, 2025 (JP) 2025-015300

(51) Int. Cl. G01P 3/38; G06V 10/25; G06V 20/56

(52) U.S. Cl. CPC G01P 3/38; G06V 10/25; G06V 20/56

(57) ABSTRACT

A vehicle speed estimation method includes: an image acquisition process of acquiring one or more images captured by one or more cameras mounted on a vehicle; an image selection process of selecting, from among the one or more images, an image or a portion of the image that does not include an object to be excluded as a target image; and a first vehicle speed estimation process of estimating a speed of the vehicle based on the target image.

### CROSS-REFERENCE TO RELATED APPLICATION

This application claims priority to Japanese Patent Application No. 2025-015300 filed on Jan. 31, 2025. The disclosure of the above-identified application, including the specification, drawings, and claims, is incorporated by reference herein in its entirety.

### BACKGROUND

### 1. Technical Field

The present disclosure relates to a method of estimating a speed of a vehicle using an image captured by an in-vehicle camera.

### 2. Description of Related Art WO 2016/016959 discloses a system that estimates a vehicle speed based on a

pixel shift amount of a specific region included in an image. The method described in WO 2016/016959 is known as a block matching method.

### SUMMARY

In a vehicle speed estimation method based on an image such as the block matching method, when an object, particularly a moving object appears in the image, the pixel shift amount may not be appropriately measured, and accurate vehicle speed estimation may not be possible. As a measure, a method is employed in which a dedicated camera is installed to capture an image of a narrow range of a road surface so that an object is as little reflected as possible. However, the measure increases the number of in-vehicle cameras.

One object of the present disclosure is to disclose a technique for estimating a vehicle speed while eliminating an influence of an object in an image.

A first aspect relates to a vehicle speed estimation method.

The vehicle speed estimation method includes:
an image acquisition process of acquiring one or more images captured by one or more cameras mounted on a vehicle;
an image selection process of selecting, from among the one or more images, an image or a portion of the image that does not include an object to be excluded, as a target image; and
a first vehicle speed estimation process of estimating a speed of the vehicle based on the target image.

According to the first aspect, since the vehicle speed estimation method includes selecting the image or the portion of the image that does not include the object to be excluded, as the target image, it is possible to suppress erroneous detection of a vehicle speed caused by the object appearing in the image. When the image selection process is performed on images captured by existing cameras used for driving assistance, the target image can be acquired. The feature contributes to reducing component costs or equipment costs of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a block matching process;

FIG. 2 is a schematic diagram showing a vehicle speed estimation system according to the present embodiment;

FIG. 3 is a schematic diagram of an image switching process;

FIG. 4 is a flowchart showing a flow of a process of an example using the vehicle speed estimation system;

FIG. 5 is a schematic diagram showing an example in which the target image is selected according to the reference speed; and

FIG. 6 is a block diagram showing a configuration example of a vehicle used in the vehicle speed estimation system.

### DETAILED DESCRIPTION OF EMBODIMENTS

Embodiments of the present disclosure will be described with reference to the accompanying drawings.

### Vehicle Speed Estimation Using Image

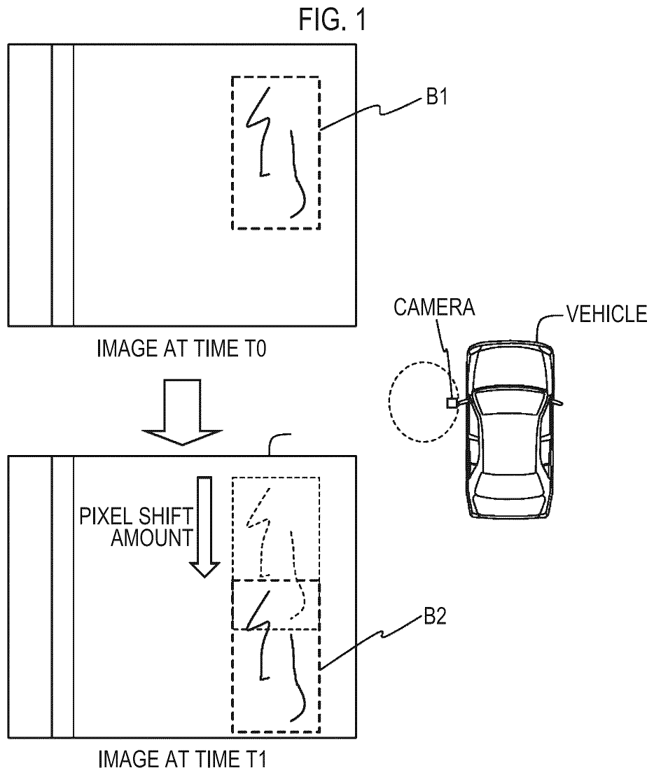

A method of estimating a vehicle speed using an image captured by a camera mounted on the vehicle is known. WO 2016/016959 discloses a vehicle speed estimation method using a block matching process that is a representative example of such a method. FIG. 1 is a schematic diagram of a block matching process. The block matching process extracts a block B1 that is a characteristic region from the image at time T0. The block B1 includes a texture unique to the region, such as a light or dark road surface or a small stone. The block matching process searches for and extracts a block B2 most similar to the block B1 in an image at a time immediately after time T0 (referred to as time T1). The sum of squared differences is used as an indicator showing the similarity between two regions. The sum of squared differences is the value obtained by squaring and summing the differences in luminance values of each pixel included in the comparison target. That is, the region where the sum of squared differences with block B1 is minimized is determined as the block B2 corresponding to block B1, and the pixel shift amount between block B1 and block B2 is calculated. The camera movement speed, that is, the vehicle speed can be obtained from the time information and the pixel shift amount. In summary, the block matching process estimates the vehicle speed based on the pixel shift amount indicating how much the reference block has moved on the image within a certain period of time.

In an actual road, many “objects” are present. The object refers to a person, another vehicle, a bicycle, a traffic light, a tree, a sign, and the like. The object does not include a road surface. In the block matching process, the object appearing in the image may reduce the accuracy of the vehicle speed estimation. In particular, the problem is significant when the object is a moving body. For example, when the block B1 referenced at time T0 includes a moving body, both the vehicle and the moving body included in the block B1 move by time T1 is reached. Therefore, the vehicle speed calculated in this case is a value including the pixel shift amount caused by the movement of the moving body, and the estimation result cannot be said to be always highly accurate. That is, in order for the block matching process to function appropriately, it is required that the object, particularly the moving object, be excluded from the image to be referred to. As a measure, a method is employed in which a camera that captures an image of a narrow range of a road surface so that the object is less likely to be included in the image is used. However, such a camera is difficult to use for a purpose other than the vehicle speed estimation. Therefore, in the vehicle speed estimation method in the related art, it is needed to additionally provide a camera for vehicle speed estimation in the vehicle.

### Selection of Target Image

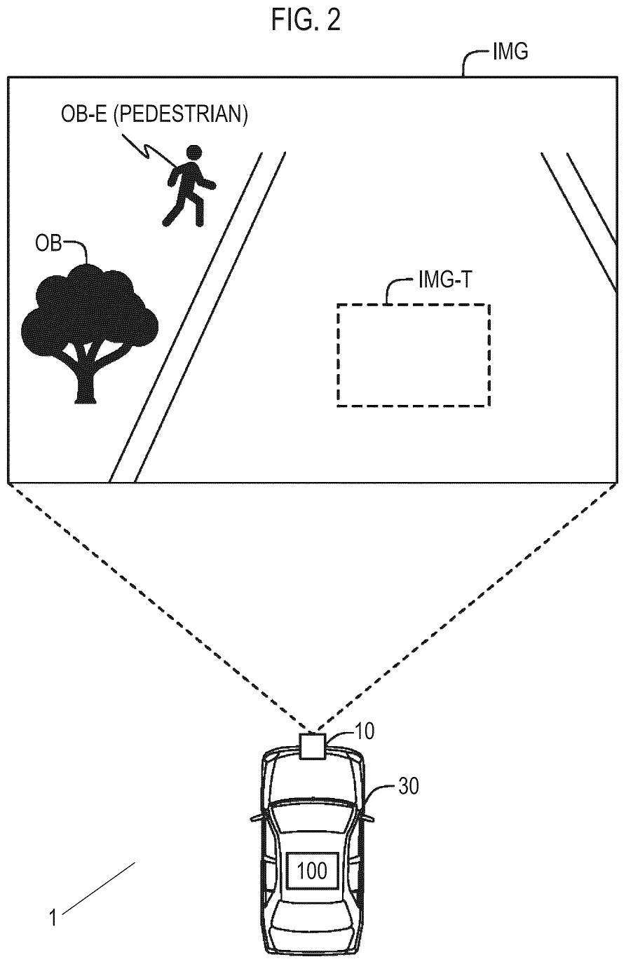

The vehicle speed estimation method according to the present embodiment is characterized by selecting a target image IMG-T according to the situation. FIG. 2 is a schematic diagram showing a vehicle speed estimation system 1 according to the present embodiment. The vehicle 30 is equipped with one or more cameras 10 (hereinafter, simply referred to as “camera 10”). The camera 10 captures one or more images IMG (hereinafter, simply referred to as “image IMG”). The object OB appears in the image IMG. Various processes related to the vehicle speed estimation system 1 are executed by one or more processors 100 (hereinafter, simply referred to as “processor 100”). The processor 100 is typically mounted on the vehicle 30.

### 2-1. Object Detection Process

The processor 100 detects an object OB appearing in the image IMG. The process is referred to as an “object detection process”. Specific examples of the object detection process include a method using image recognition and a method using remote sensing.

### Object Detection Process by Image Recognition

The processor 100 executes the object detection process by analyzing the image IMG. Specifically, the processor 100 executes the object detection process using an image recognition model. The image recognition model is a model that has learned features of many objects. The processor 100 detects the object OB based on the result recognized by the image recognition model.

### Object Detection Process by Remote Sensing

The processor 100 may execute the mobility determination process using the remote sensing. A representative example of the remote sensing is a light detection and ranging (LiDAR). The LiDAR is a system that irradiates the target object with a laser light and measures the light reflected from the target object. The distance to the target object or the direction of the target object can be calculated based on the direction in which the laser light is irradiated and the time taken for the laser light to be reflected. The processor 100 can detect the object OB included in the image IMG by associating the result of the remote sensing with the image IMG.

The processor 100 specifies the “object OB-E to be excluded” included in the object OB detected by the object detection process. The object OB-E to be excluded is an object that is preferably excluded in vehicle speed estimation. The processor 100 may regard all the objects OB detected by the object detection process as the objects OB-E to be excluded. In addition, when the object OB-E to be excluded is not present in the object OB detected by the object detection process, the image including all the detected objects OB may be used for the vehicle speed estimation. In addition, in the method described below, the moving object that is likely to affect the result of the vehicle speed estimation may be treated as the object OB-E to be excluded, and the stationary object may not be treated as the object OB-E to be excluded.

### 2-2. Image Selection Process

A specific example of the image selection process includes a “partial selection process” of extracting a portion of the image IMG. In addition, another example of the image selection process is the “image switching process” of switching the target image IMG-T used for the vehicle speed estimation when the vehicle 30 is equipped with a plurality of cameras 10.

### Partial Selection Process

An outline of the partial selection process will be described with reference to FIG. 2. The image IMG is detected by the object detection process, and the object OB-E to be excluded appears in the image IMG. In this case, the processor 100 selects the target image IMG-T that is a part of the image IMG so as not to include the object OB-E to be excluded. The processor 100 selects, for example, as the target image IMG-T, a portion that includes a unique texture from among the portions that do not include the object OB-E to be excluded.

### Image Switching Process

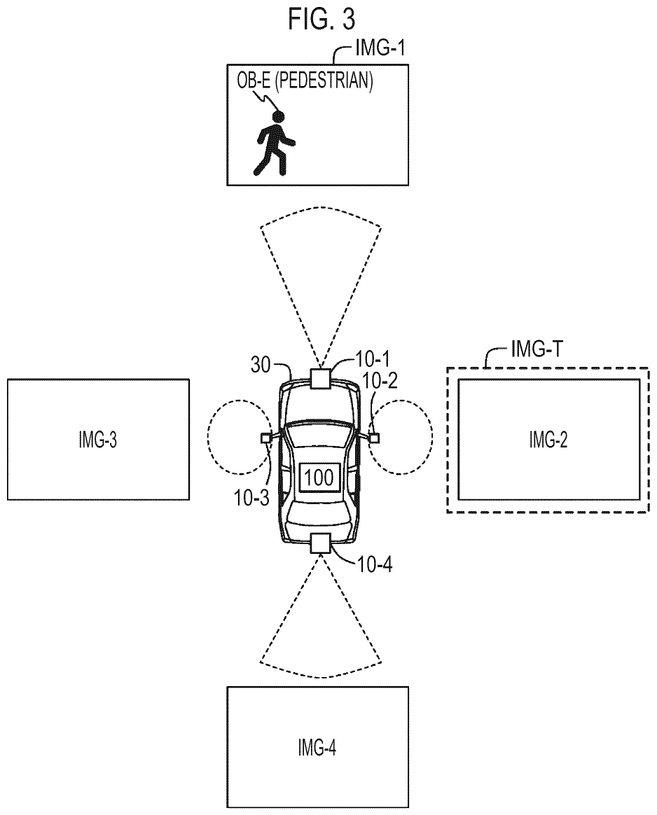

FIG. 3 is a schematic diagram of an image switching process. The vehicle 30 is equipped with a first camera 10-1 to a fourth camera 10-4. The first camera 10-1 to the fourth camera 10-4 capture the first image IMG-1 to the fourth image IMG-4, respectively. The object OB-E to be excluded appears in the first image IMG-1. The processor 100 selects, as the target image IMG-T, an image captured by a camera other than the first camera, for example, the second image IMG-2 captured by the second camera 10-2, as a range of selecting the target image IMG-T. The second image IMG-2 selected as the target image IMG-T preferably does not include the object OB-E to be excluded. Note that the processor 100 may execute the partial selection process described above on the second image IMG-2 after selecting the second image IMG-2. Therefore, the condition that the second image IMG-2 does not include the object OB-E to be excluded is not always required.

### 2-3. Mobility Determination Process

The processor 100 may determine which of the moving object and the non-moving object the object OB detected by the object detection process is classified into. The determination process is referred to as a “mobility determination process”. The moving object refers to an object that can move, such as a pedestrian, another vehicle, and a bicycle, and the non-moving object refers to an object that does not move, such as a tree, a traffic light, and a sign.

The processor 100 executes the mobility determination process using the image recognition model. In this case, the image recognition model determines the category of the object OB detected by the object detection process. For example, when the image recognition model determines the category of the detected object OB as “pedestrian”, the processor 100 regards the pedestrian as the moving object. On the other hand, in a case where the image recognition model recognizes “tree”, the processor 100 regards the tree as a non-moving object. The processor 100 treats the object OB as the object OB-E to be excluded when the object OB is the moving object, and treats the object OB as an object other than the object OB-E to be excluded when the object OB is the non-moving object. In FIG. 2, since the pedestrian who is the moving object appears in the image IMG, the processor 100 determines that the pedestrian is the object OB-E to be excluded. In other words, the processor 100 determines whether a certain object OB is a moving object or a non-moving object, and determines the object OB-E to be excluded. Therefore, the image region that can be used for the vehicle speed estimation can be made wider than when all the detected objects OB are treated as the objects OB-E to be excluded.

### 2-4. Effects

Since the vehicle speed estimation system 1 selects the image or the portion of the image that does not include the object OB-E to be excluded as the target image IMG-T, it is possible to prevent the erroneous detection of the vehicle speed caused by the object OB appearing in the image IMG. In the related art, a camera for speed detection that captures an image of solely the region directly below the vehicle is often separately introduced to eliminate the possibility that the object OB appears in the image IMG. However, the camera is not needed in the vehicle speed estimation system 1. When the image selection process is performed on images captured by existing cameras (for example, cameras for parking assistance) used for driving assistance, the target image IMG-T can be acquired. The feature contributes to reducing component costs or equipment costs of the vehicle 30.

Further, in a case where the processor 100 executes the mobility determination process, solely the moving object that significantly affects the vehicle speed estimation is regarded as the object OB-E to be excluded, such that a region for acquiring the target image IMG-T to be used for the vehicle speed estimation can be secured. In other words, the mobility determination process improves the efficiency of the vehicle speed estimation.

### Application Example

### 3-1. Flow of Process

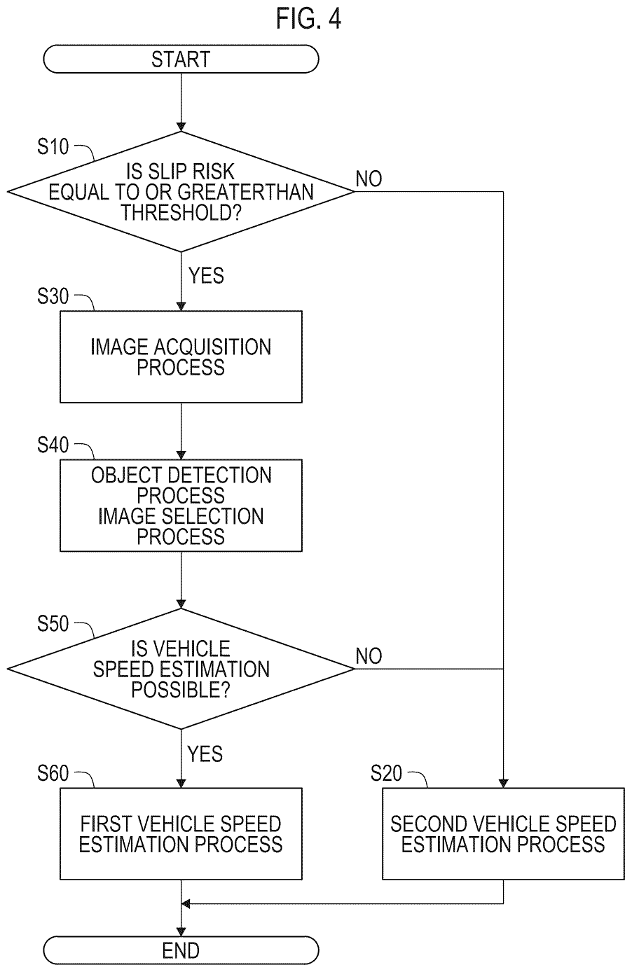

FIG. 4 is a flowchart showing a flow of a process of an example using the vehicle speed estimation system 1.

In S10, the processor 100 determines whether the slip risk of the wheels is equal to or greater than a threshold. The slip risk is calculated by considering, for example, the difference in the rotation speed of each wheel detected by a wheel rotation speed sensor mounted on the vehicle 30. That is, when the difference in the rotation speed of each wheel is small, it means that all the wheels are rotating in synchrony, and the slip risk is calculated to be small. On the other hand, when the difference in the rotation speed is large, all the wheels are not rotated in synchrony, and the slip risk is calculated to be large. When the calculated slip risk is equal to or greater than the threshold (S10; YES), the process proceeds to S30. On the other hand, when the calculated slip risk is smaller than the threshold (S10; NO), the process proceeds to S20.

In S30, the processor 100 executes the image acquisition process. The image acquisition process is a process of acquiring an image IMG captured by the camera 10. The acquired image IMG is used for the object detection process and the image selection process in S40 that follows.

In S40, the processor 100 executes the object detection process and the image selection process as described in section 2. In the image selection process, the processor 100 may execute the mobility determination process of the detected object OB. The process proceeds to S50.

In S50, the processor 100 determines whether the vehicle speed estimation based on the vehicle speed estimation system 1 can be performed. In an actual situation, the target image IMG-T suitable for the vehicle speed estimation may not always be acquired. For example, in a case where the vehicle travels in the rain, the water droplets or the dirt may adhere to all of the cameras 10, and a case may be considered in which the appropriate target image IMG-T cannot be acquired. In addition, it is also difficult to acquire an appropriate target image IMG-T in a tunnel. In such a case (S50; NO), the process proceeds to S20. When determination is made that the vehicle speed estimation based on the vehicle speed estimation system 1 can be performed (S50; YES), the process proceeds to S60.

In S60, the processor 100 estimates the speed of the vehicle 30 based on the target image IMG-T selected in the image selection process. The vehicle speed estimation based on the target image IMG-T is referred to as a “first vehicle speed estimation process”. The image processing in the first vehicle speed estimation process itself may be the same as a conventional method, such as the block matching process. Thereafter, the process ends.

In S20, the processor 100 executes the second vehicle speed estimation process. The second vehicle speed estimation process is a vehicle speed estimation process different from the first vehicle speed estimation process. The second vehicle speed estimation process is, for example, an existing method using a wheel rotation speed sensor. In S20, since the slip risk is sufficiently small (see S10), even the vehicle speed estimation based on the rotation speed of the wheels has sufficiently high reliability.

As shown in FIG. 4, the vehicle speed estimation system 1 is particularly effective in a situation where the wheels are likely to slip and the vehicle speed estimation using the wheel speed sensor is difficult (for example, when traveling on sandy or dirt roads).

### 3-2. Selection of Target Image According to Reference Speed

The processor 100 may select the target image IMG-T according to an approximate vehicle speed (reference speed Vref) of the vehicle 30. The reference speed Vref is acquired by a method different from the first vehicle speed estimation process. For example, the processor 100 acquires the reference speed Vref by integrating the value of the acceleration acquired by the sensor that detects the acceleration acting on the vehicle body. More specifically, in a situation where the slip risk is smaller than the threshold (S10; NO), the vehicle speed is estimated with high accuracy by the second vehicle speed estimation process described above. The processor 100 stores, as an initial value, the high-accuracy vehicle speed obtained by the second vehicle speed estimation process immediately before the determination result of S10 changes from NO to YES. Thereafter, the processor 100 can calculate the reference speed Vref by adding the integration of the longitudinal acceleration of the vehicle 30 over a predetermined period to the initial value. The longitudinal acceleration is detected by a longitudinal acceleration sensor mounted on the vehicle 30. In the next step, the processor 100 integrates the longitudinal acceleration of the vehicle 30 over the next predetermined period and adds the integrated value to the calculated reference speed Vref as an initial value to obtain the latest reference speed Vref. In this way, the processor 100 continuously acquires the latest reference speed Vref.

As another example, the processor 100 may acquire the position information of the vehicle 30 using the GPS sensor mounted on the vehicle 30 and acquire the reference speed Vref according to the change in the position of the vehicle 30.

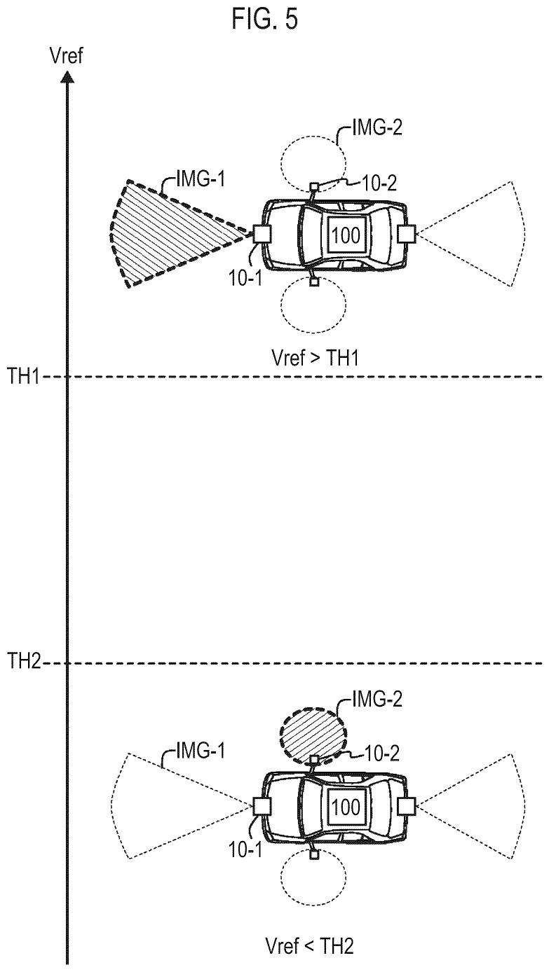

FIG. 5 is a schematic diagram showing an example in which the target image IMG-T is selected according to the reference speed Vref. The vehicle 30 includes a first camera 10-1 and a second camera 10-2. The first camera 10-1 captures an image of a region farther than an image of a region captured by the second camera 10-2, and typically captures an image of a front or a rear of the vehicle 30. The second camera 10-2 captures an image of a region closer to the vehicle 30 than the region of which the image is captured by the first camera 10-1 is, and typically captures an image of a side of the vehicle 30. In a case where the reference speed Vref is greater than the first threshold value TH1, the processor 100 selects the first image IMG-1 captured by the first camera 10-1 or a portion of the first image IMG-1 as the target image IMG-T. In a case where the reference speed Vref is smaller than the second threshold value TH2, the vehicle speed estimation system 1 selects the second image IMG-2 captured by the second camera 10-2 or a portion of the second image IMG-2 as the target image IMG-T. The second threshold value TH2 is set to be smaller than the first threshold value TH1.

In summary, the processor 100 uses the first image IMG-1 capturing an image of the farther region as the target image IMG-T when the reference speed Vref is relatively high, and uses the second image IMG-2 capturing an image of a region closer to the vehicle 30 as the target image IMG-T when the reference speed Vref is relatively low. When a short-range camera is used at high speeds, the movement amount of the target in the image IMG may become too large to appropriately measure the pixel shift amount. For example, the block B1 may be out of the field of view of the camera 10 in the next frame. In addition, when a long-range camera is used at low speeds, the movement amount of the target in the image IMG may become too small to appropriately measure the pixel shift amount. For example, even when the target located in the farther region moves relative to the vehicle 30 traveling at a low speed, the movement amount in the image IMG may not be precisely measured in pixel units. Selecting the target image IMG-T based on the reference speed Vref is effective in preventing such a situation.

### Configuration Example

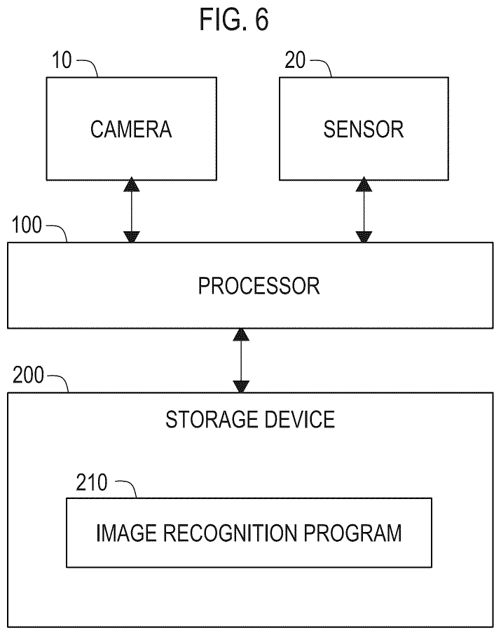

FIG. 6 is a block diagram showing a configuration example of a vehicle 30 used in the vehicle speed estimation system 1.

The camera 10 captures images of the surroundings of the vehicle 30. The sensor 20 detects a state of the vehicle 30 or a surrounding situation. The sensor 20 includes a sensor used for the LiDAR, a longitudinal acceleration sensor used for calculating the reference speed Vref, and a wheel rotation speed sensor.

The processor 100 executes various processes based on the information acquired from the camera 10 or the sensor 20. Examples of the processor 100 include a general-purpose processor, a specific-purpose processor, a CPU, a GPU, an ASIC, an FPGA, an integrated circuit, a conventional circuit, and/or a combination thereof. The processor 100 can also be referred to as circuitry or processing circuitry.

The vehicle 30 includes a storage device 200. Examples of the storage device 200 include a volatile memory, a non-volatile memory, an HDD, and an SSD. The functions are implemented by collaboration between the processor 100 and the storage device 200 of the vehicle speed estimation system 1. The storage device 200 stores an image recognition program 210. By the processor 100 executing the image recognition program 210, the functions of the image recognition model used for the object detection process and the mobility determination process are implemented.

What is claimed is:

1. A vehicle speed estimation method comprising:
an image acquisition process of acquiring one or more images captured by one or more cameras mounted on a vehicle;
an image selection process of selecting, from among the one or more images, an image or a portion of the image that does not include an object to be excluded, as a target image; and
a first vehicle speed estimation process of estimating a speed of the vehicle based on the target image.

2. The vehicle speed estimation method according to claim 1, wherein the object to be excluded includes a moving object and does not include a non-moving object.

3. The vehicle speed estimation method according to claim 1, further comprising a process of estimating the speed of the vehicle as a reference speed by a method different from the first vehicle speed estimation process,
wherein the image selection process includes selecting the target image in accordance with the reference speed.

4. The vehicle speed estimation method according to claim 3, wherein:
the one or more cameras include
a first camera, and
a second camera configured to capture an image of a region closer to the vehicle than a region of which an image is captured by the first camera is; and
when the reference speed is greater than a first threshold, the target image includes a first image captured by the first camera or a portion of the first image.

5. The vehicle speed estimation method according to claim 4, wherein:
a second threshold is a value smaller than the first threshold; and
when the reference speed is smaller than the second threshold, the target image includes a second image captured by the second camera or a portion of the second image.
